(19) United States
(12) Patent Application Publication
(10) Pub. No.: US 2018/0107019 A1
(43) Pub. Date: Apr. 19, 2018

(54) NOSE PAD FOR EYEGLASS

(71) Applicant: PROHERO GROUP CO., LTD., Tainan City (TW)

(72) Inventor: PEN-WEI CHEN, TAINAN CITY (TW)

(21) Appl. No.: 15/292,457

(22) Filed: Oct. 13, 2016

(51) Int. Cl. G02C 5/12

(52) U.S. Cl. CPC G02C 5/12; G02C 2200/16

(57) ABSTRACT

A nose pad for eyeglass comprises a main body which is set at the inner side of the eyeglass frame to correspond to human's nose. The main body is a hollow body and filled with a gas. Accordingly, the nose pad has the function of floating on the water. Furthermore, the hollow nose pad is supported on the user's nose to effectively decrease the weight pressed on the bridge of the user's nose, achieving the comfortable effect.

### BACKGROUND OF THE INVENTION

### Field of the Invention

The present invention relates to a nose pad for eyeglass. More particularly, the weight pressed on the bridge of the user's nose can be decreased by a nose pad for eyeglass, achieving the lightweight effect.

### Description of Related Art

All of the structure of the nose pad for the general eyeglass has a nose pad element. For a combined eyeglass frame, the nose pad element has a joining element to connect with an eyeglass frame by a screw or other engagement method. Furthermore, the general nose pad element is is thick; however, oriental people usually have flat nose, the eyeglass with the general nose pad always falls off, resulting in out of focus, the vision cannot be adjusted appropriately. Moreover, if the user uses the eyeglass with the general nose pad during exercise or sweating, the eyeglass is easier to falls off to cause damage.

Whatever kind of nose pad is set on the eyeglass, it is made of hard rubber. When it is used, the middle section of the eyeglass can be supported on the bridge of user's nose, however, the disadvantage is that the hard rubber does not have elasticity to cause indentation marker in the skin of the nose when using for a long time, resulting in uncomfortable feeling. Moreover, when the eyeglass is impacted, the force received by the hard rubber directly acts to the nose bridge, resulting in injury to the nose.

Therefore, the inventor provided a nose pad for eyeglass, which the present structure and disadvantage are improved according to his experience in the development of the related industry, having more applicability.

### SUMMARY OF THE INVENTION

Therefore, the object of the present invention is related to a nose pad for eyeglass. More particularly, the weight pressed on the bridge of the user's nose can be decreased by a nose pad for eyeglass, achieving is the lightweight effect.

For the above object, a nose pad for eyeglass comprises a main body which is set at the inner side of the eyeglass frame to correspond to human's nose. The main body is a hollow body and filled with a gas. Accordingly, the nose pad has the function of floating on the water. Furthermore, the hollow nose pad is supported on the user's nose to effectively decrease the weight pressed on the bridge of the user's nose, achieving the comfortable effect.

According to an embodiment of the present invention, the main body has a chamber filled with a gas.

According to an embodiment of the present invention, the main body is filled with the gas during injection molding.

According to an embodiment of the present invention, the gas is nitrogen.

Accordingly, the nose pad for eyeglasses of the present invention has the advantages as following:

1. The eyeglass is supported on the bridge of the user's nose by the nose pad filled with the gas of the present invention, so the weight pressed on the bridge of the user's nose is effectively decreased, achieving the comfortable effect.

2. Because the nose pad of the present invention is filled with the gas inside, the eyeglass can float on the water for convenient searching.

3. Because the nose pad of the present invention is filled with the gas inside, the eyeglass is lightweight design.

4. Because the nose pad of the present invention is filled with the gas inside, the usage of plastic material is decreased effectively, achieving the effect of saving cost.

### BRIEF DESCRIPTION OF THE DRAWINGS

FIG. 1 is a three-dimensional view of a nose pad for eyeglass according to an embodiment of the present invention;

FIG. 2 is a side view of a nose pad for eyeglass according to an embodiment of the present invention; and

FIG. 3 is a sectional view of a nose pad for eyeglass according to an embodiment of the present invention.

### DETAILED DESCRIPTION OF THE PREFERRED EMBODIMENT

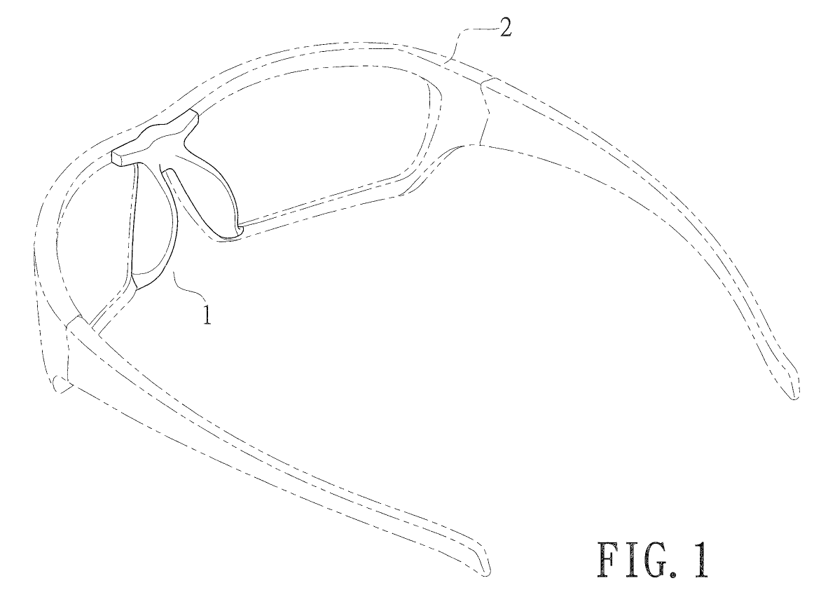

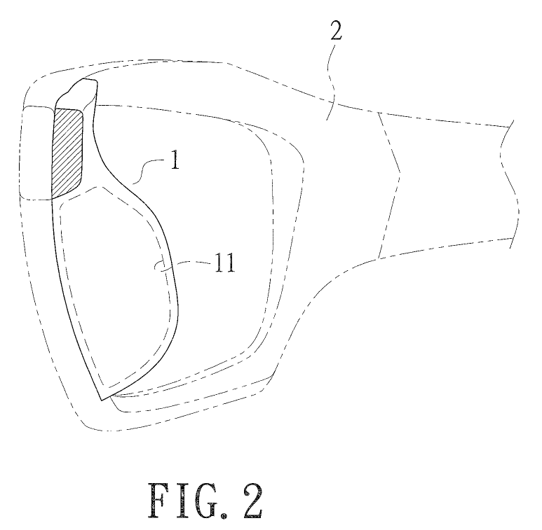

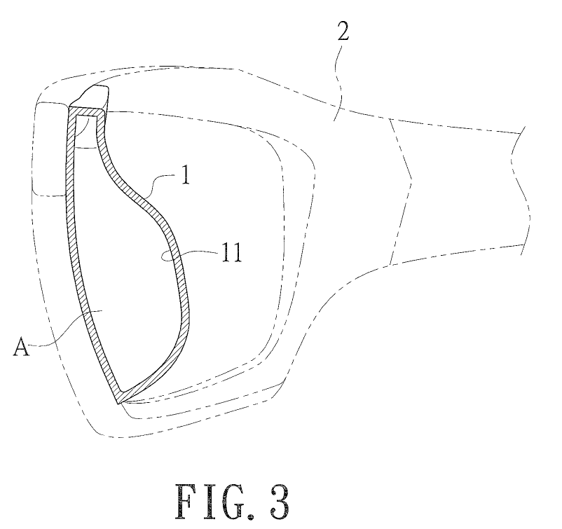

Please refer to FIG. 1 to FIG. 3, which are a three-dimensional view, a side view, and a sectional view of a nose pad for eyeglass according to an embodiment of the present invention, respectively. The nose pad comprises a pair of main body 1, corresponding to connect with an eyeglass frame 2 and having a chamber 11 filled with a gas A.

Please refer to FIG. 1 to FIG. 3. When the nose pad of the present invention is assembled to an eyeglass shown as FIG. 1, a pair of nose pad is a main body 1 with two separation arms or is formed of two main bodies 1 which are integrally formed. The main body 1 is corresponded to connect with the eyeglass frame 2 by attachment or screw. In detail, the main body 1 is at the inner side of the eyeglass frame 2 and corresponded to the bridge of the user's nose. The main body 1 is made with a chamber 11 inside, and the chamber 11 is filled with a gas A, making the main body 1 with elasticity. Furthermore, the main body 1 is filled with the gas A during injection molding, and the gas A is nitrogen, which is high stable.

When the user wears the eyeglass having the nose pad of the present invention, the weight pressed on the bridge of the user's nose is decreased by the supporting force from the gas, and the weight of the whole eyeglass is decreased effectively. Furthermore, under the contact between the bridge of the user's nose and the nose pad of the present invention, the user feels gentle touch and comfortable wearing.

According to the above description and embodiments, the nose pad of eyeglass of the present invention has the advantages as following:

1. The eyeglass is supported on the bridge of the user's nose by the nose pad filled with the gas of the present invention, so the weight pressed on the bridge of the user's nose is effectively decreased, achieving the comfortable effect.

2. Because the nose pad of the present invention is filled with the gas inside, the eyeglass can float on the water for convenient searching.

3. Because the nose pad of the present invention is filled with the gas inside, the eyeglass is lightweight design.

4. Because the nose pad of the present invention is filled with the gas inside, the usage of plastic material is decreased effectively, achieving the effect of saving cost.

What is claimed is:

1. A nose pad for eyeglass, comprising:
a pair of main body, corresponding to connect with an eyeglass frame and having a chamber filled with a gas.

2. The nose pad for eyeglass according to claim 1, wherein the main body is filled with the gas during injection molding.

3. The nose pad for eyeglass according to claim 1, wherein the gas is nitrogen.

4. The nose pad for eyeglass according to claim 2, wherein the gas is nitrogen.
